(19) United States
(12) Patent Application Publication
(10) Pub. No.: US 2008/0175640 A1
(43) Pub. Date: Jul. 24, 2008

(54) IMAGE FORMING APPARATUS

(75) Inventor: Takaya Akiyama, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/017,476

(22) Filed: Jan. 22, 2008

(30) Foreign Application Priority Data
Jan. 22, 2007 (JP) 2007-011338

(51) Int. Cl. G03G 15/00

(52) U.S. Cl. 399/405

(57) ABSTRACT

An image forming apparatus is provided with a box-shaped apparatus main body internally including an image forming assembly; an image reader arranged atop the apparatus main body; an operation unit arranged before the image reader for giving specified operation information on an image forming operation; a discharge unit arranged between the apparatus main body and the image reader, including a discharge tray to which a sheet after image formation is discharged and being open at least at front for sheet removal; and a supporting column arranged at a lateral side of the discharge unit for supporting the image reader and formed with a discharge port through which a sheet is discharged to the discharge tray. A clearance is formed between the operation unit and the supporting column, extends to the front end of the image reader and enables a part of the discharge tray to be seen.

### SUMMARY OF THE INVENTION

1. Field of the Invention

The present invention relates to an image forming apparatus such as a printer, a copier, a facsimile machine or a complex machine having functions of these apparatuses.

2. Description of the Related Art

There has been known an image forming apparatus of the so-called internal discharge type in which an image reader is arranged via a discharge unit atop an apparatus main body internally including an image forming assembly and a sheet feeding assembly as disclosed, for example, in Japanese Unexamined Patent Publications Nos. 2006-58689 and 2004-355019. In such an apparatus, a sheet having an image formed thereon in the apparatus main body is discharged to a discharge tray of the discharge unit arranged between the image reader and the apparatus main body.

However, with the image forming apparatus of the internal discharge type, it is difficult for a user standing face to face with the front surface of the apparatus to see the discharge tray as compared to image forming apparatuses of the type in which sheets are discharged on the upper or side surfaces of the apparatuses. Specifically, the image reader located at the top of the apparatus, an operation panel attached to a front position of the image reader and the like block the gaze of the user to interfere with the visibility of the discharge tray (discharge unit). Accordingly, it is proposed in the above two patent documents to recess a part of the operation panel backward, so that a sheet discharged onto the discharge tray can be obliquely seen from a front upper side.

However, the visibility of sheets to be discharged onto the discharge tray is not necessarily improved only by recessing the part of the operation panel backward. For example, in the case of discharging a small-size sheet, this sheet might not be seen only by recessing the part of the operation panel. Even if the part of the operation panel is largely recessed, the user might not be able to see a sheet, for example, in the case where the sheet conveyed with its shorter sides aligned with a conveying direction is discharged when the recess is formed without considering a sheet discharge position.

### SUMMARY OF THE INVENTION

An object of the present invention is to improve the visibility of a discharge tray (discharge unit) in an image forming apparatus of the internal discharge type.

In order to accomplish this object, one aspect of the present invention is directed to an image forming apparatus, comprising a box-shaped apparatus main body internally including an image forming assembly; an image reader arranged atop the apparatus main body; an operation unit arranged before the image reader for giving specified operation information on an image forming operation; a discharge unit arranged between the apparatus main body and the image reader, including a discharge tray to which a sheet after image formation is discharged and being open at least at front for sheet removal; and a supporting column arranged at a lateral side of the discharge unit for supporting the image reader and formed with a discharge port through which a sheet is discharged to the discharge tray. A clearance is formed between the operation unit and the supporting column, extends to the front end of the image reader and enables a part of the discharge tray to be seen.

Another aspect of the present invention is directed to an image forming apparatus, comprising an apparatus main body, an image reader, an operation unit, a discharge unit and a supporting column similar to the above, wherein the front end of the image reader is located at a position more backward than the front end of the discharge tray while the front end of the supporting column is located substantially at the same position as that of the discharge tray; the operation unit is arranged to take up a part of a space before the image reader and above the discharge tray; and a clearance enabling a part of the discharge tray to be seen when viewed from above is formed between the operation unit and the supporting column.

These and other objects, features, aspects and advantages of the present invention will become more apparent upon a reading of the following detailed description and accompanying drawings.

### BRIEF DESCRIPTION OF THE DRAWINGS

FIG. 1 is a perspective view showing the external appearance of a copier as an example of an image forming apparatus according to the present invention,

FIG. 2 is a section schematically showing the internal construction of the copier,

FIG. 3 is a top view of the copier shown in FIG. 1,

FIG. 4 is an enlarged perspective view of a part including a clearance G seen in a direction of the gaze of a user standing right face to face with the front surface of the copier,

FIGS. 5A and 5B are top views showing a sliding state of an operation panel,

FIG. 6 is an enlarged perspective view showing a part including a clearance G according to a modification, and

FIG. 7 is a perspective view showing the external appearance of a copier according to a modification.

### DETAILED DESCRIPTION OF THE PREFERRED EMBODIMENTS

Hereinafter, one specific embodiment of the present invention is described with reference to the accompanying drawings.

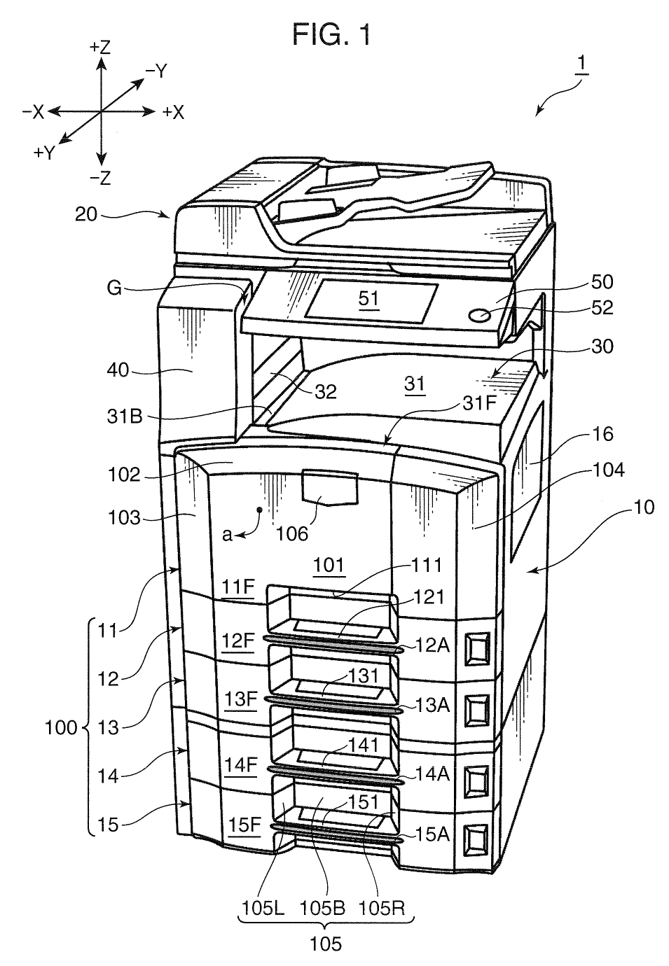

FIG. 1 is a perspective view showing the external appearance of a copier 1 as an example of an image forming apparatus according to the present invention. In FIG. 1 and other figures, X-X directions are transverse directions, Y-Y directions are forward and backward directions, and Z-Z directions are vertical directions, wherein +X direction is rightward direction; −X direction leftward direction; +Y direction forward direction; −Y direction backward direction; +Z direction upward direction; and −Z direction downward direction.

The copier 1 is of the so-called internal discharge type, and is provided with a box-shaped apparatus main body 10 internally including an image forming assembly and a sheet feeding assembly, an image reader 20 arranged atop the apparatus main body 10, and a discharge unit 30 which is arranged between the apparatus main body 10 and the image reader 20, to which a sheet after image formation is discharged and which is open at least at front for the removal of the sheet.

An apparatus front cover 100 constructed such that a plurality of unit cover members, which can be opened forward, are vertically arranged is provided on the front surface of the apparatus main body 10. In this embodiment is shown an example in which the unit cover members of the apparatus front cover 100 include a decorative surface 11F of an opening cover 11 arranged at the uppermost position and decorative covers 12F to 15F of first to fourth sheet cassettes 12 to 15 arranged one below another in vertical direction below the decorative surface 11F.

As shown by an arrow “a” in FIG. 1, the opening cover 11 can be opened and closed in a front left direction about the left end thereof as a rotary shaft. On the other hand, the first to fourth sheet cassettes 12 to 15 are respectively so mounted in the apparatus main body 10 as to be withdrawable forward. Further, the opening cover 11 and the first to fourth sheet cassettes 12 to 15 are respectively provided with grips 111, 121, 131, 141 and 151 used for their opening/closing movements.

The apparatus front cover 100 has a vertically long rectangular shape when the front surface of the apparatus main body 10 is viewed from front. The apparatus front cover 100 includes a projecting flat surface 101 projecting more forward than the peripheral edges of the apparatus front cover 100, and three inclined surfaces formed to extend from the end edges of the projecting flat surface 101 to the peripheral edges of the apparatus front cover 100. The three inclined surfaces include an arcuate inclined surface 102 formed from the upper side of the projecting flat surface 101 to the upper peripheral edge of the apparatus front cover 100, and left and right inclined surfaces 103, 104 formed from the left and right sides of the projecting flat surface 101 to the left and right peripheral edges of the apparatus front cover 100.

A recessed part 105 vertically extending over the decorative surface 11F of the opening cover 11 and the decorative covers 12F to 15F of the first to fourth sheet cassettes 12 to 15 is formed at a transverse middle position of the projecting flat surface 101. The recessed part 105 includes a bottom surface 105B recessed by a specified depth relative to the projecting flat surface 101, and a pair of left and right inclined surfaces 105L, 105R formed to extend from the bottom surface 105B toward the opening edge in such a manner as to increase the opening width.

The aforementioned grips 111 to 151 are arranged in vertical direction in this recessed part 105. Further, colored portions 12A, 13A, 14A and 15A having a color different from that of the projecting flat surface 101 are provided on the front sides of the grips 121 to 151 of the first to fourth sheet cassettes 12 to 15, so that the positions of the grips 121 to 151 can be clearly recognized. Further, an emblem 106 is attached at an upper middle position of the apparatus front cover 100 (opening cover 11).

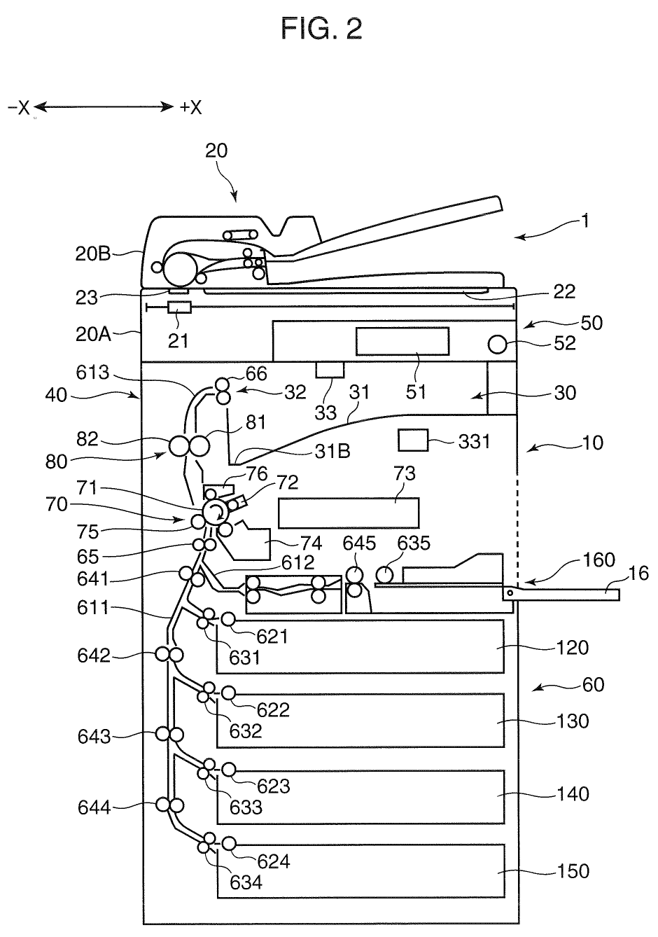

The image reader 20 is arranged atop the apparatus main body 10 via a space for the discharge unit 30. The image reader 20 is supported by a supporting column 40 arranged at the left side of the upper surface of the apparatus main body 10 and a side wall arranged at the back side of the upper surface of the apparatus main body 10. This image reader 20 includes an automatic document feed unit 20B for feeding a document to be copied to a document reading position and thereafter discharging the document and a scanner unit 20A having an optical system for reading the image of the document (see FIG. 2).

The discharge unit 30 is a unit to which a sheet having an image formed thereon in the apparatus main body 10 in accordance with a document image read by the image reader 20 is discharged and includes a discharge tray 31 and a discharge port 32. The discharge port 32 is an opening formed in the right surface (surface facing the discharge unit 30) of the supporting column 40 and enabling a sheet after image formation to be discharged from the apparatus main body 10. The discharge tray 31 is a sheet receiving surface for receiving the sheet being discharged from this discharge port 32. The discharge tray 31 is a surface moderately inclined downward from right to left when viewed from front and has a lowest bottom portion 31B in a part adjacent to the discharge port 32. By such an inclination, sheets discharged from the discharge port 32 to the discharge tray 31 can have the trailing ends thereof in a sheet conveying direction aligned in the vicinity (bottom portion 31B) of the discharge port 32.

The supporting column 40 located at the left side of the discharge unit 30 has substantially the same dimension as the apparatus main body 10 in forward and backward directions. In other words, the front end (front surface) of the supporting column 40 is located substantially at the same position as a front end 31F of the discharge tray 31. On the other hand, the front end of the image reader 20 is retracted by a specified length from the front end 31F of the discharge tray 31. This means that a user standing right face to face with the front surface of the copier 1 and obliquely seeing from a front upper side can see the discharge unit 30 while being interfered by the image reader 20 (and an operation panel 50) as little as possible.

The operation panel 50 is so mounted on the front surface of the image reader 20 as to be slidable in transverse direction. The operation panel 50 is arranged to take up a part of a space located before the image reader 20 and above the discharge tray 31. A clearance G is formed between this operation panel 50 and the supporting column 40. Thus, the user can see a part of the discharge tray 31 of the internal discharge type from above through the clearance G. This clearance G is described in detail later.

The operation panel 50 is for receiving various operation instructions and setting instructions from the user. Here are shown an operation display 51 including a liquid crystal display (LCD) or the like for displaying operation guide information and the like used to input the setting and the like for various copying operations and displaying various operation buttons and the like, and a start key 52 used by the user to enter a print instruction. Besides these, a numeric keypad and the like for receiving inputs such as the number of copies to be printed are provided.

Next, the internal construction of the copier 1 is described. FIG. 2 is a section schematically showing the internal construction of the copier 1. As described above, the copier 1 is provided with the apparatus main body 10 having the supporting column 40 on the upper surface, the image reader 20, the discharge unit 30 and the operation panel 50. The apparatus main body 10 is internally provided with the sheet feeding assembly 60, the image forming assembly 70 and a fixing device 80.

The image reader 20 includes the scanner unit 20A and the automatic document feed unit 20B arranged atop the scanner unit 20A. The scanner unit 20A internally includes a movable frame 21 having an exposure lamp for irradiating the document with light. In addition, a CCD (Charge Coupled Device) sensor for generating an image data by photoelectrically converting a reflected light from a document, an optical system for introducing the reflected light to the CCD sensor and the like are built in the scanner unit 20A although they are not shown. Furthermore, a first platen glass 22 for reading a placed document and a second platen glass 23 for reading automatically fed documents are provided on the upper surface of the scanner unit 20A.

The automatic document feed unit 20B includes a feed tray for storing documents to be read, and a receiving portion for receiving the documents after the reading. The automatic document feed unit 20B feeds the documents from the feed tray to the document reading position of the second platen glass 23 and discharges the documents after the reading to the receiving portion by the operation of a document conveying mechanism provided inside.

An illumination member 33 for illuminating the space of the discharge unit 30 is mounted on the rear wall facing the space of the discharge unit 30. An incandescent lamp, an LED lamp or the like can be used as such an illumination member 33. Further, a controller 331 for controlling a lighting operation of the illumination member 33 is provided in the apparatus main body 10. This controller 331 executes a control of not only turning the illumination member 33 on when an unillustrated lighting switch is pressed down, but also automatically turning the illumination member 33 on when a sliding movement of the operation panel 50 is detected.

The sheet feeding assembly 60 of the apparatus main body 10 is for feeding a sheet (recording sheet) to the image forming assembly 70. The sheet feeding assembly 60 includes first to fourth sheet storing portions 120 to 150 respectively corresponding to the aforementioned first to fourth sheet cassettes 12 to 15 and adapted to accommodate sheets of various sizes, and a manual sheet feeder 160 comprised of a manual feed tray 16 openably and closably mounted at the right side of the apparatus main body 10. Although not shown, the first to fourth sheet storing portions 120 to 150 include cursors for positioning sheet stacks, lifters for bringing the uppermost sheets into contact with pickup rollers 621 to 624 to be described later by elastically lifting the sheet stacks, and the like.

Sheet conveyance paths for conveying sheets are provided from such a sheet feeding assembly 60 to the discharge port 32 via the image forming assembly 70 and the fixing device 80. Such sheet conveyance paths include a first sheet conveyance path 611 extending from the first to fourth sheet storing portions 120 to 150 to the image forming assembly 70, a second sheet conveyance path 612 extending from the manual sheet feeder 160 to the image forming assembly 70 and a third sheet conveyance path 613 extending from the image forming assembly 70 to the discharge port 32.

The pickup rollers 621, 622, 623 and 624 for picking up the accommodated sheets one by one and feed roller pairs 631, 632, 633 and 634 arranged downstream of these pickup rollers are provided at upper parts of sheet take-out sides of the first to fourth sheet storing portions 120 to 150. The feed roller pairs 631, 632, 633 and 634 are for feeding the picked-up sheets to the first sheet conveyance path 611.

The first sheet conveyance path 611 includes conveyance roller pairs 641, 642, 643 and 644 for conveying the sheet to the image forming assembly 70. The second sheet conveyance path 612 includes a feed roller 635 for taking in a manually fed sheet and a conveyance roller pair 645 for conveying this manually fed sheet toward the image forming assembly 70. Further, a registration roller pair 65 for causing the sheet to wait on standby before the image forming assembly 70 is provided at an end position of the first sheet conveyance path 611. A discharge roller pair 66 for conveying (discharging) the sheet toward the discharge unit 30 is arranged at an end position of the third sheet conveyance path 613, and the discharge port 32 is so provided as to extend along the discharge roller pair 66.

The image forming assembly 70 transfers a toner image to a sheet conveyed from the sheet feeding assembly 60 based on the image data of a document obtained in the image reader 20. The image forming assembly 70 includes a photoconductive drum 71 rotatably provided about an axis, and a charger 72, an exposing device 73, a developing device 74, a transfer roller 75 and a cleaning device 76 arranged along the circumferential surface of the photoconductive drum 71.

The photoconductive drum 71 is for forming an electrostatic latent image and a toner image in conformity with this electrostatic latent image on the circumferential surface thereof. An amorphous silicon photoconductive drum having an amorphous silicon layer formed on the circumferential surface thereof is suitably used as the photoconductive drum 71.

The charger 72 is for uniformly charging the circumferential surface of the photoconductive drum 71 rotating clockwise about its center axis. A charger of the type to impart electric charges to the circumferential surface of the photoconductive drum 71 by corona discharge can be used as the charger 72. Alternatively, a charging roller for imparting electric charges to the photoconductive drum 71 while being rotated by the photoconductive drum 71 with the circumferential surface thereof held in contact with the circumferential surface of the photoconductive drum 71 may be used.

The exposing device 73 irradiates the circumferential surface of the rotating photoconductive drum 71 with a laser beam modulated based on the image data. Electric charges are removed from parts of the circumferential surface of the photoconductive drum 71 irradiated with the laser beam, whereby an electrostatic latent image in conformity with a laser beam irradiation pattern is formed on the circumferential surface of the photoconductive drum 71.

The developing device 74 supplies toner particles to the circumferential surface of the photoconductive drum 71 via a developing roller built therein. When the toner particles are supplied to the photoconductive drum 71, they are attached to a part where the electrostatic latent image is formed, whereby a toner image is formed on the circumferential surface of the photoconductive drum 71. An unillustrated toner container is detachably attached to the developing device 74, and toner particles are resupplied from this toner container when the toner particles in the developing device 74 are used up.

The transfer roller 75 forms a nip portion together with the photoconductive drum 71 and transfers the toner image formed on the circumferential surface of the photoconductive drum 71 to a sheet fed to the nip portion. The toner image on the circumferential surface of the photoconductive drum 71 is positively charged. On the other hand, the transfer roller 75 imparts negative electric charges having a polarity opposite to the electric charges of the toner image to the sheet. The positively charged toner image on the circumferential surface of the photoconductive drum 71 is peeled off toward the front surface of the negatively charged sheet to be transferred to the sheet.

The cleaning device 76 cleans the circumferential surface of the photoconductive drum 71 by removing the toner residual thereon after a transfer process. The circumferential surface of the photoconductive drum 71 cleaned by this cleaning device 76 moves toward the charger 72 again for a next image forming process.

The fixing device 80 is for fixing the toner image transferred to the sheet in the image forming assembly 70 to the sheet by heating. The fixing device 80 includes a heat roller 81 having an electric heating element mounted therein and a pressure roller 82 whose circumferential surface is opposed to that of the heat roller 81. The sheet after the transfer process passes through a nip portion between the heat roller 81 driven to rotate and the pressure roller 82 rotated by the heat roller 81 in an opposite direction to have a fixing process applied thereto by obtaining heat from the heat roller 81. The sheet having the fixing process applied thereto is discharged to the discharge unit 30 via the third sheet conveyance path 613 and the discharge roller pair 66.

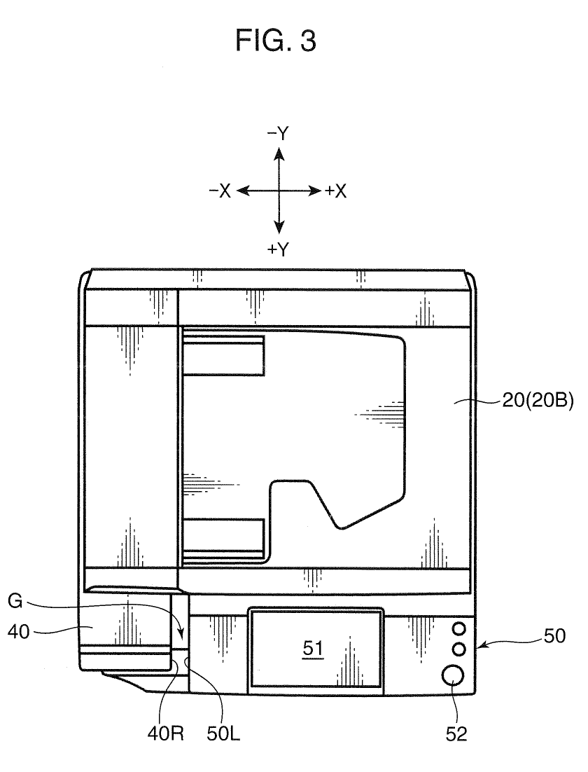

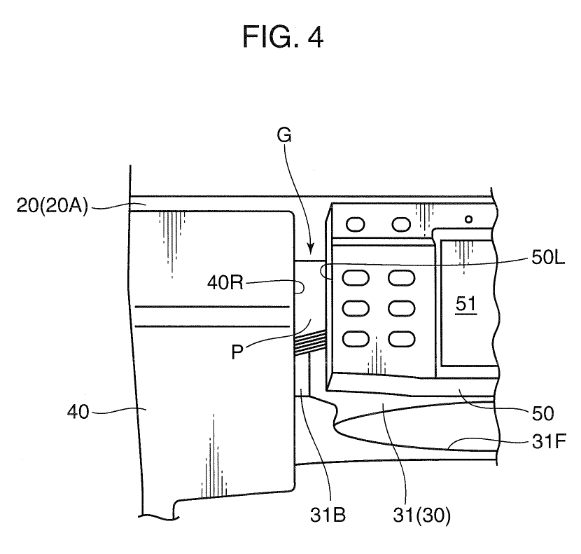

Next, the clearance G formed between the operation panel 50 and the supporting column 40 is described in detail. FIG. 3 is a top view of the copier 1 and FIG. 4 is an enlarged perspective view of a part including the clearance G seen in a direction of the gaze of the user standing right face to face with the front surface of the copier 1. As shown in FIG. 3, the operation panel 50 has a rectangular box structure narrow and long in transverse direction when viewed from above, wherein an operation display portion 51 is arranged substantially in the center and a start key 52 is arranged at the right end side. A left end 50L of the operation panel 50 is a flat surface parallel to forward and backward directions.

The supporting column 40 is a box structure having substantially the same width in forward and backward directions as the apparatus main body 10 in order to conform to the sizes of the aforementioned fixing device 80 and third sheet conveyance path 613 and having a rectangular cross section longer in forward and backward directions along an X-Y plane. Since the width of the image reader 20 in forward and backward directions is shorter than that of the apparatus main body 10 in forward and backward directions, the front side of the supporting column 40 is exposed without being covered by the image reader 20. Further, a right end 40R of the supporting column 40 is a flat surface parallel to forward and backward directions.

The clearance G in the form of a slit long in forward and backward directions is formed between the right end 40R of the supporting column 40 and the left end 50L of the operation panel 50. In other words, the size of the operation panel 50 is set such that the left end 50L of the operation panel 50 does not interfere with the right end 40R of the supporting column 40 when viewed from above. The operation panel 50 is arranged in the space before the image reader 20 and above the discharge tray 31. By the above size setting, the front side of the upper surface of the supporting column 40 is exposed without being covered by the operation panel 50 and a part of the discharge tray 31 adjacent to the right end 40R of the supporting column 40 is also exposed.

Since such a clearance G is provided, the user can see a sheet P discharged to the discharge tray 31 through the clearance G while standing right face to face with the front surface of the copier 1 (see FIG. 4). The clearance G is located at a position retracted from the front end 31F of the discharge tray 31 and extends up to the front end of the image reader 20. Thus, the part of the discharge tray 31 can be seen up to a very deep position, and the user can certainly see this sheet P even if a small-size sheet P is discharged to the discharge tray 31. Particularly, since this clearance G is located substantially right above the discharge port 32 and corresponds to the position of the bottom portion 31B at the lowest position of the discharge tray 31 where the trailing end of the discharged sheet in the conveying direction is aligned, the user can certainly see whether or not any sheet is present on the discharge tray 31 or whether or not any sheet is being discharged.

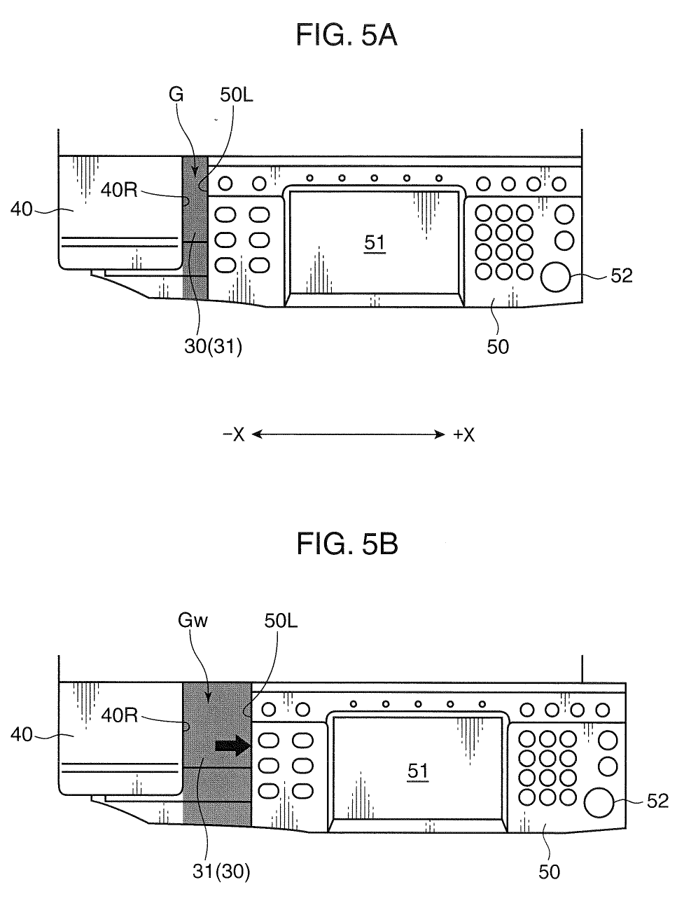

As described above, the operation panel 50 is so mounted on the front surface of the image reader 20 as to be slidable in transverse direction. FIGS. 5A and 5B are top views showing a sliding state of the operation panel 50. FIG. 5A shows a stationary state of the operation panel 50. This state is a home position of the operation panel 50 and the clearance G at this time is in the form of a narrow slit.

On the other hand, FIG. 5B shows a state of the operation panel 50 sliding in a direction of an arrow. At this time, since the spacing between the right end 40R of the supporting column 40 and the left end 50L of the operation panel 50 is widened, the clearance G becomes a clearance Gw whose transverse dimension is extended. The user can see the discharge tray 31 in a wider range through this extended clearance Gw.

Further, the sliding movement of the operation panel 50 is detected by the controller 331 and the illumination member 33 (see FIG. 1) is turned on. This is to provide the user with better visibility by illuminating the space of the discharge unit 30 by understanding the sliding movement of the operation panel 50 as the indication of the user's intension to see the discharge unit 30.

One of various known sliding mechanisms can be adopted as a sliding mechanism for the operation panel 50. For example, a guide rail extending in transverse direction may be arranged on the front surface of the scanner unit 20A and a movable member capable of running on the guide rail may be attached to the rear surface of the operation panel 50. In this case, it is desirable to provide stoppers for defining a movable range of the operation panel 50 and a biasing member for constantly biasing the operation panel 50 toward the home position.

By adopting such a sliding mechanism, the user can slide the operation panel 50 and see the discharge unit 30 through the wide clearance Gw only by pushing the operation panel 50 to right by the hand. If the user releases his or her hand from the operation panel 50 after seeing the discharge unit 30, the operation panel 50 can be returned to the home position by the biasing force of the biasing member.

According to the copier 1 constructed as above, the clearance G enabling the part of the discharge tray 31 to be seen is provided between the right end 40R of the supporting column 40 formed with the discharge port 32 and the left end 50L of the operation panel 50, the visibility of the sheet P discharged to the discharge tray 31 can be improved. Accordingly, even if the discharge unit 30 is of the internal discharge type and the discharge end of the sheet P after image formation is structurally difficult to see in the image forming apparatus 1, whether or not the sheet P has been discharged to the discharge tray 31 can be made more easily confirmable, with the result that accessibility to the sheet P can be improved.

The copier 1 according to the embodiment of the present invention is described above, but the present invention is not limited thereto and may be embodied, for example, as follows.

(1) The above embodiment is described taking the copier 1 as an example of the image forming apparatus. It goes without saying that the present invention is also applicable to other image forming apparatuses such as printers, facsimile machines or complex machines of these.

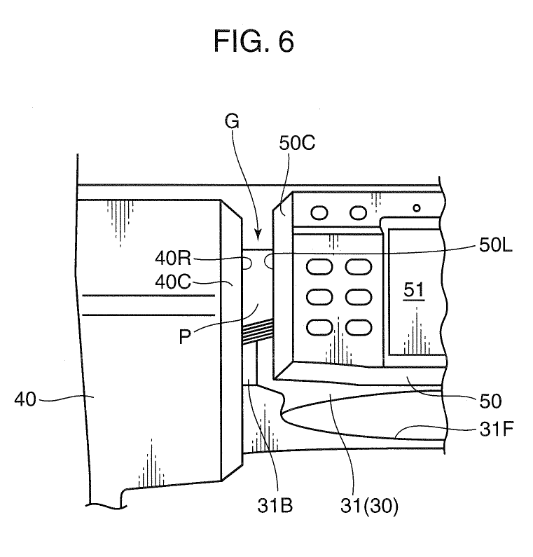

(2) It is preferable to provide inclined surfaces 40C, 50C inclined down toward the clearance G on the upper sides of the right end 40R of the supporting column 40 and the left end 50L of the operation panel 50 as shown in FIG. 6. These inclined surfaces 40C, 50C may be so-called “C-surfaces” formed by chamfering corners of a cube or may have shapes approximate to C-surfaces. By providing such inclined surfaces 40C, 50C, the discharge tray 31 can be easily seen even if the clearance G becomes narrower or the clearance G is seen not only from right above, but also in an oblique direction from the left or right side.

(3) Although the operation panel 50 is slidable in transverse direction in the above embodiment, it may be fixed to the front surface of the image reader 20. Alternatively, the operation panel 50 may be pivotally movable upward and downward with the rear end thereof as an axis of rotation. In this case, the operation panel 50 does not interfere with the supporting column 40 even if being pivotally moved since it the clearance G is defined between the operation panel 50 and the supporting column 40.

(4) Although the illumination member 33 for illuminating the space of the discharge unit 30 is turned on in synchronism with the sliding movement of the operation panel 50 in the above embodiment, the use of the illumination member 33 may be omitted.

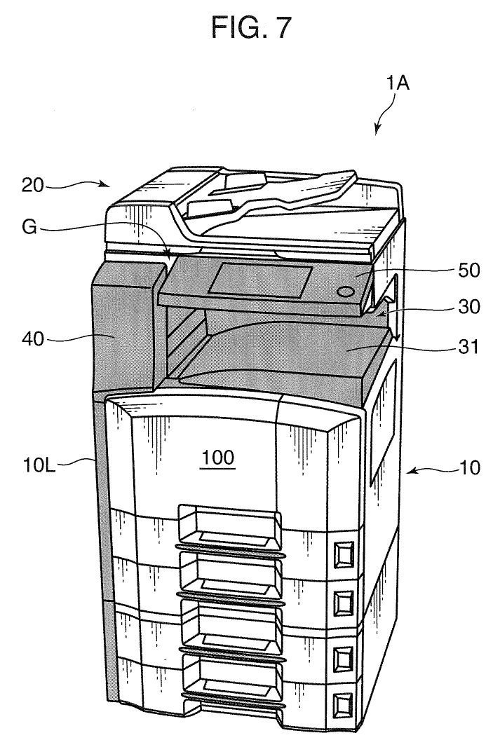

(5) The color of the copier 1 may be a single color, e.g. an ivory color, but preferably has such coloration as to make the discharge unit 30 of the internal discharge type striking. FIG. 7 is a perspective view showing a copier 1A in which the visibility of the discharge unit 30 is improved by colors. Here is shown an example in which the discharge unit 30 (discharge tray 31), the supporting column 40, the operation panel 50 and a left edge portion 10L of the apparatus main body 10 have a deeper (darker) color than other parts. By doing so, it is possible not only to improve the design by two-tone colors, but also to make the discharge unit 30, which is structurally difficult to find by being of the internal discharge type, more striking by colors.

In this case, the color of the discharge tray 31 is preferably selected from a range of 1 to 5 in lightness represented by Munsell values of the Munsell chart (JIS). By letting the discharge tray 31 have such a dark color, contrast with white sheets can be improved, wherefore the user can more easily recognize the sheet discharged to the discharge unit 31.

Further, in FIG. 7, a difference in lightness between the color of the discharge tray 31, the supporting column 40, the operation panel 50 and the left edge portion 10L of the apparatus main body 10 and the color of the apparatus front cover 100 is preferably 3 or greater in the Munsell value of the Munsell chart (JIS). By having such a lightness difference, contrast between the vicinity of the discharge unit 30 and the apparatus front cover 100 can be improved and the discharge unit 30 can be made even more striking.

(6) In the above embodiment, the front end of the image reader 20 is located at the position retracted from the front end 31F of the discharge tray 31 and the operation panel 50 is arranged to take up the part of the space before the image reader 20 and above the discharge tray 31. However, if the front end of the supporting column 40 projects forward from the front end 31F of the discharge tray 31, the front end of the image reader 20 may be located substantially at the same position as or project from the front end 31F of the discharge tray 31 and the operation panel 50 may be attached to the front end of such an image reader 20.

The specific embodiment described above mainly embraces inventions having the following constructions.

An image forming apparatus according to one aspect of the present invention comprises a box-shaped apparatus main body internally including an image forming assembly; an image reader arranged atop the apparatus main body; an operation unit arranged before the image reader for giving specified operation information on an image forming operation; a discharge unit arranged between the apparatus main body and the image reader, including a discharge tray to which a sheet after image formation is discharged and being open at least at front for sheet removal; and a supporting column arranged at a lateral side of the discharge unit for supporting the image reader and formed with a discharge port through which a sheet is discharged to the discharge tray, wherein a clearance is formed between the operation unit and the supporting column, extends to the front end of the image reader and enables a part of the discharge tray to be seen.

An image forming apparatus according to another aspect of the present invention comprises a box-shaped apparatus main body internally including an image forming assembly; an image reader arranged atop the apparatus main body; an operation unit for giving specified operation information on an image forming operation; a discharge unit arranged between the apparatus main body and the image reader, including a discharge tray to which a sheet after image formation is discharged and being open at least at front for sheet removal; and a supporting column arranged at a lateral side of the discharge unit for supporting the image reader and formed with a discharge port through which a sheet is discharged to the discharge tray, wherein the front end of the image reader is located at a position more backward than the front end of the discharge tray while the front end of the supporting column is located substantially at the same position as that of the discharge tray; the operation unit is arranged to take up a part of a space before the image reader and above the discharge tray; and a clearance enabling a part of the discharge tray to be seen when viewed from above is formed between the operation unit and the supporting column.

According to these constructions, in the image forming apparatus of the internal discharge type, the clearance enabling the part of the discharge tray to be seen is formed between the supporting column formed with the discharge port and the operation unit located before the image reader and above the discharge tray. This clearance extends up to the front end of the image reader. Thus, a user can see the part of the discharge tray of the internal discharge type up to a very deep position through the clearance while standing right face to face with the front surface of the image forming apparatus. Accordingly, even if a small-size sheet is discharged to the discharge tray, the user can certainly see this sheet. Further, since the clearance is present at the position where the vicinity of the discharge port can be seen, a state of the sheet being discharged from the discharge port can be confirmed. Even if a sheet conveyed with its shorter sides aligned with a conveying direction is discharged, the sheet can be certainly seen.

In any of the above constructions, the discharge tray is preferably an inclined surface whose part adjacent to the discharge port is located at its lowest position.

According to this construction, a sheet discharged to the discharge tray has the trailing end thereof in the conveying direction aligned in the vicinity of the discharge port by the inclined surface. Thus, the sheet comes to be reliably located at a position of the discharge tray visible through the clearance, wherefore the visibility of the sheet on the discharge tray can be further improved.

In any of the above constructions, the operation unit is preferably slidable in transverse direction to make the width of the clearance adjustable.

According to this construction, the user can see the discharge tray in a wider range by sliding the operation unit if necessary to widen the width of the clearance.

In this case, it is preferable that an illumination member for illuminating the space of the discharge unit and a controller for controlling the operation of the illumination member are further provided; and that the controller turns the illumination member on when a sliding movement of the operation unit is detected.

According to this construction, since the space of the discharge unit is illuminated according to the sliding movement of the operation unit, i.e. since the space of the discharge unit is illuminated according to the user's intension to see the discharge unit, it can be made even easier to see the discharge unit.

In any of the above constructions, it is preferable to provide inclined surfaces inclined down toward the clearance on lateral ends of the operation unit and the supporting column adjacent to the clearance.

According to this construction, since the inclined surfaces inclined toward the clearance are provided, the discharge tray can be seen even if the clearance is narrowed or it is seen not only from right above, but also in an oblique direction from the left or right side.

According to the image forming apparatuses of the present invention described above, the clearance extending up to the front end of the image reader and enabling the part of the discharge tray to be seen is formed between the supporting column formed with the discharge port and the operation unit located before the image reader and above the discharge tray. Thus, the visibility of sheets to be discharged to the discharge tray can be improved. Therefore, it is possible to improve accessibility to sheets after image formation and to provide a user-friendly image forming apparatus.

This application is based on patent application No. 2007-011338 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image forming apparatus, comprising:
a box-shaped apparatus main body internally including an image forming assembly;
an image reader arranged atop the apparatus main body;
an operation unit arranged before the image reader for giving specified operation information on an image forming operation;
a discharge unit arranged between the apparatus main body and the image reader, including a discharge tray to which a sheet after image formation is discharged and being open at least at front for sheet removal; and
a supporting column arranged at a lateral side of the discharge unit for supporting the image reader and formed with a discharge port through which a sheet is discharged to the discharge tray,
wherein a clearance is formed between the operation unit and the supporting column, extends to the front end of the image reader and enables a part of the discharge tray to be seen.

2. An image forming apparatus according to claim 1, wherein the discharge tray is an inclined surface whose part adjacent to the discharge port is located at its lowest position.

3. An image forming apparatus according to claim 1, wherein the operation unit is slidable in transverse direction to make the width of the clearance adjustable.

4. An image forming apparatus according to claim 3, further comprising:
an illumination member for illuminating the space of the discharge unit; and
a controller for controlling the operation of the illumination member;
wherein the controller turns the illumination member on when a sliding movement of the operation unit is detected.

5. An image forming apparatus according to claim 1, wherein inclined surfaces inclined down toward the clearance are provided on lateral ends of the operation unit and the supporting column adjacent to the clearance.

6. An image forming apparatus, comprising:
a box-shaped apparatus main body internally including an image forming assembly;
an image reader arranged atop the apparatus main body;
an operation unit for giving specified operation information on an image forming operation;
a discharge unit arranged between the apparatus main body and the image reader, including a discharge tray to which a sheet after image formation is discharged and being open at least at front for sheet removal; and
a supporting column arranged at a lateral side of the discharge unit for supporting the image reader and formed with a discharge port through which a sheet is discharged to the discharge tray,
wherein:
the front end of the image reader is located at a position more backward than the front end of the discharge tray while the front end of the supporting column is located substantially at the same position as that of the discharge tray;
the operation unit is arranged to take up a part of a space before the image reader and above the discharge tray; and
a clearance enabling a part of the discharge tray to be seen when viewed from above is formed between the operation unit and the supporting column.

7. An image forming apparatus according to claim 6, wherein the discharge tray is an inclined surface whose part adjacent to the discharge port is located at its lowest position.

8. An image forming apparatus according to claim 6 wherein the operation unit is slidable in transverse direction to make the width of the clearance adjustable.

9. An image forming apparatus according to claim 8 further comprising:
an illumination member for illuminating the space of the discharge unit; and
a controller for controlling the operation of the illumination member;
wherein the controller turns the illumination member on when a sliding movement of the operation unit is detected.

10. An image forming apparatus according to claim 6, wherein inclined surfaces inclined down toward the clearance are provided on lateral ends of the operation unit and the supporting column adjacent to the clearance.
